(19) United States
(12) Patent Application Publication
(10) Pub. No.: US 2009/0094880 A1
(43) Pub. Date: Apr. 16, 2009

(54) FISHING APPARATUSES AND ASSOCIATED METHODS OF MANUFACTURE

(76) Inventors: Kurt T. Gifford, Lino Lakes, MN (US); Michael A. Garin, Mahtomedi, MN (US)

Correspondence Address: PERKINS COIE LLP;PATENT-SEA, P.O. BOX 1247, SEATTLE, WA, 98111-1247, US

(21) Appl. No.: 12/249,769

(22) Filed: Oct. 10, 2008

Related U.S. Application Data
(60) Provisional application No. 60/979,803, filed on Oct. 12, 2007.

(51) Int. Cl. A01K 95/00; B23P 17/00

(52) U.S. Cl. 43/43.1; 29/527.1; 43/44.87

(57) ABSTRACT

Fishing devices for use with a fishing line are disclosed herein. In one embodiment, a fishing sinker includes a body and a connector. The body includes first and second portions. The first portion includes a hole that extends along an axis between first and second surfaces. The second portion defines a concave channel extending from the first body at an oblique angle with respect to the axis. The connector is rotatably positioned in the hole and couples the body to the fishing line.

### CROSS-REFERENCE TO RELATED APPLICATIONS

The present application claims priority to U.S. Provisional Patent Application No. 60/979,803, filed on Oct. 12, 2007, entitled FISHING COMPONENT AND ASSOCIATED METHODS, which is hereby incorporated by reference in its entirety.

### TECHNICAL FIELD

The following disclosure relates generally to fishing apparatuses and associated methods of manufacturing and, more particularly, to fishing sinkers.

### BACKGROUND

Fishing using a fishing line generally includes attracting fish with bait disposed on a hook connected to the fishing line. Typically, the ability to simulate lifelike action of the bait can enhance the likelihood that a fish will be interested in the bait and strike the hook.

Conventionally, a person fishing with the line attempts to create the lifelike action by various movements, e.g., tugs, on the fishing line. When an appreciable amount of fishing line is paid out between the person's movements and the bait, as is frequently the case, the person's movements may have to be exaggerated to impart sufficient action to the bait and/or the person may become erratic in their movements and thus the action of the bait can also become erratic. This can make the bait less attractive to the fish, and thereby decrease the likelihood that the person will be successful catching a fish.

### BRIEF DESCRIPTION OF THE DRAWINGS

FIG. 1 is an isometric view of a fishing sinker apparatus configured in accordance with an embodiment of the disclosure.

FIG. 2 is a profile view of the fishing sinker apparatus shown in FIG. 1.

FIG. 3 is a plan view of a fishing sinker body configured in accordance with an embodiment of the disclosure.

FIG. 4 is an end view of the fishing sinker body shown in FIG. 3.

FIG. 5 is a cross-sectional view, taken along a central plane, of the fishing sinker body shown in FIG. 3.

FIGS. 6A and 6B are cross-sectional views of fishing sinker bodies configured in accordance with other embodiments of the disclosure.

FIGS. 7A to 7C are isometric views of a mold configured in accordance with embodiments of the disclosure for manufacturing the sinker apparatus shown in FIGS. 3 to 5.

FIG. 8 is a schematic illustration of a method in accordance with an embodiment of the disclosure for using the sinker apparatus shown in FIG. 1.

### DETAILED DESCRIPTION

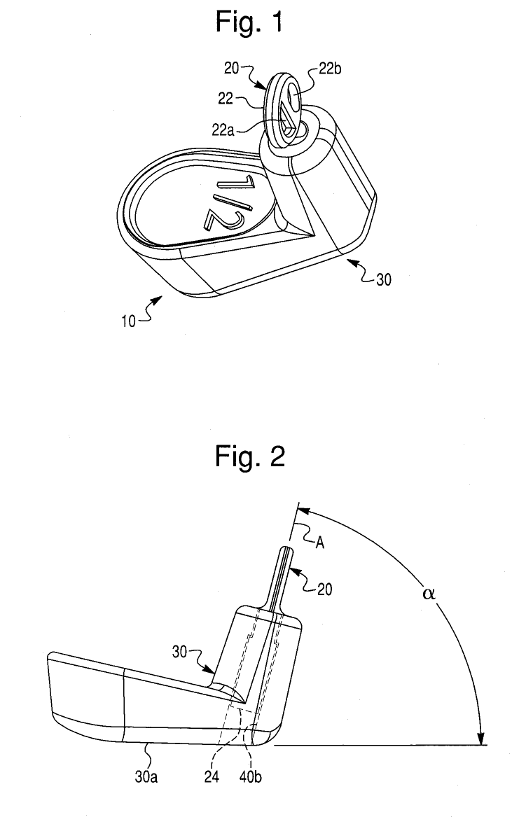

The following disclosure describes several embodiments of fishing sinkers for use with fishing line and bait. As it is used in the present disclosure, the term “bait” can include, for example, live bait, e.g., a worm, artificial bait, e.g., a lure, etc. Specific details of several embodiments of the invention are described below with reference to FIGS. 1 to 8 to provide a thorough understanding of the embodiments. Other details describing well-known structures and systems often associated with fishing systems, however, are not set forth below to avoid unnecessarily obscuring the description of the various embodiments. Accordingly, those of ordinary skill in the art will understand that the invention may have other embodiments in addition to those described below. Such embodiments may include other elements and features in addition to those described below, or they may lack one or more of the features or elements described below.

In the Figures, identical reference numbers identify identical or at least generally similar elements. To facilitate the discussion of any particular element, the most significant digit or digits of any reference number refer to the Figure in which that element is first introduced.

FIG. 1 is an isometric view of a sinker apparatus 10 configured in accordance with an embodiment of the disclosure. The sinker apparatus 10 generally includes a fishing line connector 20 and a sinker body 30. Some embodiments of the fishing line connector 20 are described in U.S. Pat. No. 3,805,439 to Krengel et al., which is hereby incorporated by reference in its entirety. According to the embodiment shown in FIG. 1 of the present disclosure, the fishing line connector 20 can include a loop portion 22 fixed to a shank portion 24 (shown in FIG. 2). The loop portion 22 can include an eye 22a and a snap 22b. The eye 22a can be used to tie a fishing line (not shown in FIG. 1) onto the fishing line connector 20, and the snap 22b can be used to quickly fasten the connector 20 to a fishing line swivel (not shown in FIG. 1) or the like. The shank portion 24 can be rotatably retained in the body 30.

FIG. 2 is a profile view of the sinker apparatus 10 showing an embodiment of a relationship between fishing line connector 20 and the sinker body 30. In the embodiment shown in FIG. 2, the fishing line connector 20 extends along an axis A that is disposed at an angle α with respect to a base 30a of the body 30. The angle α can be from about 60 degrees to about 80 degrees, e.g., approximately 75 degrees, or the angle α can be any angle that is suitable for orienting the base 30a with respect to water flow as will be described hereinafter.

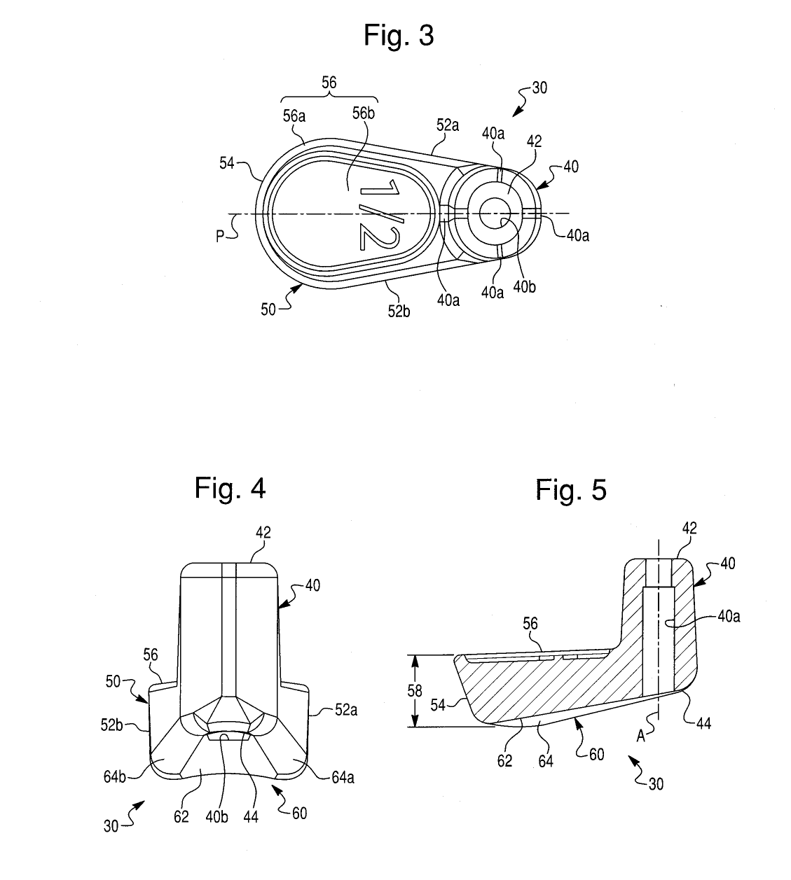

FIGS. 3 and 4 are plan and end views, respectively, of a sinker body 30 configured in accordance with an embodiment of the disclosure. In the embodiment shown in FIGS. 3 and 4, the sinker body 30 per se does not include the fishing line connector 20. The sinker body 30 can generally include a cylindrical first body portion 40 adjoining a second body portion 50 that outwardly projects from the first body portion 40. In the embodiment shown in FIGS. 3 and 4, the first and second body portions 40 and 50 can be integrally formed, e.g., cast, injection molded, etc., from a homogeneous material having a suitable density, e.g., lead, copper, bismuth, steel, brass, tungsten, tungsten-nickel alloy, tin, densified polymers, etc.

The first body portion 40 extends between a first surface 42 and a second surface 44 that is spaced from the first surface 42. The first surface 42 is proximate to the loop portion 22 and can be generally perpendicular to the axis A. In some embodiments, the second surface 44 can be configured as an extension of the second body portion 50. In the embodiment shown in FIGS. 3 and 4, the first body portion 40 can have a generally cylindrical form that can include rounded edges at the first and second surfaces 42 and 44. The first body portion 40 can have a generally round cross-section with one or more planar sections 40a (four are shown in FIG. 3) positioned around the first body portion 40. The first body portion 40 also includes a hole 40b extending along the axis A between the first and second surfaces 42 and 44.

The second body portion 50 includes side surfaces (individual side surfaces 52a and 52b are indicated) that extend from the first body portion 40 to a relatively distal end surface 54. With reference to the plan view shown in FIG. 3, the side surfaces 52 appear as straight segments that flare outward with respect to one another toward the end surface 54, and the end surface 54 appears as an arcuate segment that connects distal end portions of the side surfaces 52. Other embodiments according to the present disclosure can have side and end surfaces that can include flat planes, circular cylindrical surfaces, or combinations thereof.

The second body portion 50 can include an intermediate surface 56 outwardly extending from the first body portion 40. The intermediate surface 56 can adjoin the side surfaces 52 and the end surface 54. With particular reference to FIG. 4, the intermediate surface 56 is positioned along the first body portion 40 between the first and second surfaces 42 and 44. The intermediate surface 56 can include a lip portion 56a surrounding a relief portion 56b. The relief portion 56b can be embossed, printed, or otherwise suitably marked with indicia 56c, e.g., identifying an approximate weight of the device 30.

The second body portion 50 can further include a channel surface 60 proximate to the second surface 44. With reference to FIG. 4, the channel surface 60 can include a generally centrally located, concave recess 62 positioned between ridges (individual ridges 64a and 64b are indicated). The channel surface 60 can project obliquely from the first body portion 40, e.g., generally at a relative angular orientation approximately equal to the angle α. As shown in the embodiment according to FIG. 4, individual ridges 64 can include convex surfaces connecting the recess 62 to respective individual side surfaces 56.

FIG. 5 is a cross-sectional view, taken along a centrally located plane P, of the fishing sinker apparatus shown in FIG. 3. In the embodiment shown in FIG. 5, the central location of the plane P defines an imaginary divider with symmetrical, or at least approximately symmetrical portions of the body 30 disposed on both sides of a plane P. As shown in FIG. 5, the hole 40b extends along the axis A between the first and second surfaces 42 and 44 of the first body portion 40. As is also shown in FIG. 5, the channel surface 60 is generally disposed with respect to the axis A approximately at the angle α, the ridges 64 (only one is shown in FIG. 5) can extend approximately from the hole 40a in the second surface 44 toward the end surface 54, and the recess 62 extends approximately parallel to the plane P between the ridges 64. In the embodiment shown in FIG. 5, the position of the intermediate surface 56 along the first body portion 40 is closer to the second surface 44 than the first surface 42, thereby defining an approximate thickness 58 between the intermediate and channel surfaces 56 and 60.

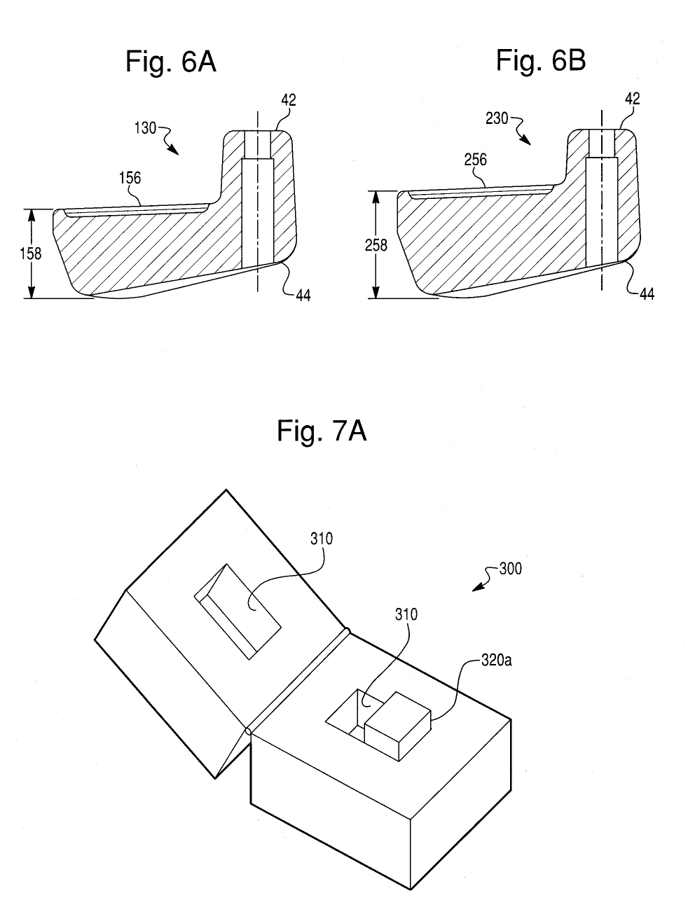

FIGS. 6A and 6B are cross-sectional views of sinker bodies 130 and 230, respectively, configured in accordance with other embodiments of the disclosure. As compared to the embodiment shown in FIG. 5, FIG. 6A shows the position of an intermediate surface 156 along the first body portion 40 is approximately equidistant from the first and second surfaces 42 and 44 thereby defining an approximate thickness 158, and FIG. 6B shows the position of an intermediate surface 256 along the first body portion 40 is closer to the first surface 42 than the second surface 44 thereby defining an approximate thickness 258. Accordingly, the approximate thickness 158, the volume of the sinker body 130, and therefore the approximate weight of the sinker body 130, is greater in the embodiment of FIG. 6A than the approximate thickness 58, volume and approximate weight of the sinker body 30 in the embodiment of FIG. 5, and the approximate thickness 258, volume and approximate weight of the sinker body 230 in the embodiment of FIG. 6B is greater than the approximate thickness 158, volume and approximate weight of the sinker body 130 in the embodiment of FIG. 6A.

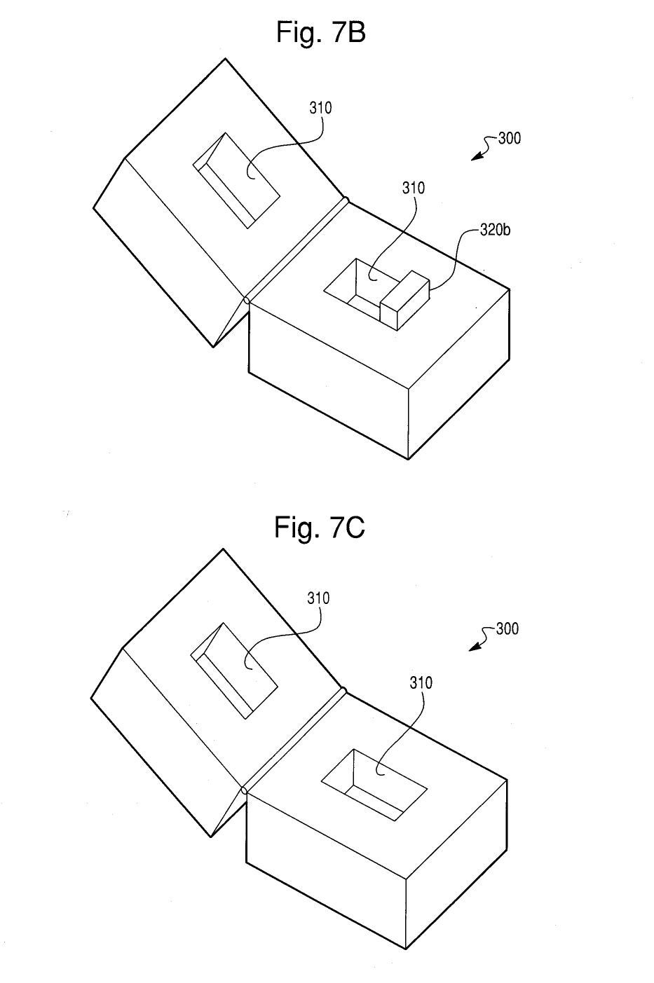

FIGS. 7A to 7C are isometric views of a mold 300 defining a mold cavity 310 configured in accordance with embodiments of the disclosure for manufacturing the sinker bodies shown in FIGS. 3 to 5. Varying the volume and weight of the sinker body 30 as compared to the sinker body 130 or the sinker body 230 can be achieved, for example, by a method of manufacturing that includes casting the body 30, 130 or 230 in the same mold 300 and varying the volume of the mold cavity 310 based on the selective insertion into the mold cavity 310 of a core 320 that defines the intermediate surface 56, 156 or 256 with respect to the channel surface 60. For example, as shown in FIG. 7A, a relatively large core 320a can be inserted in the mold cavity 310 during casting of the sinker body 30 shown in FIG. 5. As shown in FIG. 7B, a relatively small core 320b can be inserted in the same mold cavity 310 in lieu of the relatively large core 320a during casting of the sinker body 130 shown in FIG. 6A. As shown in FIG. 7C, the same mold 300 and mold cavity 310 can be used without a core during casting of the sinker body 230 shown in FIG. 6B. In other embodiments according to the present disclosure, additional relatively sized cores can be used to cast additional sizes of sinker bodies using the same mold 300. Accordingly, an advantage of the present disclosure is the capability to use a single mold to cast different size sinker bodies.

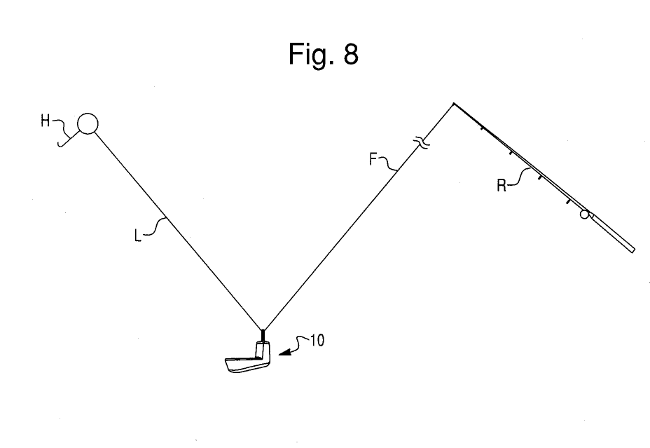

FIG. 8 is a schematic illustration of a method in accordance with an embodiment of the present disclosure using, for example, the sinker apparatus 10 shown in FIG. 1. FIG. 8 shows a fishing line F extending from a fishing rod R to the sinker apparatus 10 according to an embodiment of the present disclosure, and a leader line L extending from the sinker apparatus 10 to a conventional hook and bait arrangement H.

According to the embodiment shown in FIG. 8, the fishing sinker device 10 according to an embodiment of the present disclosure can be connected to the fishing and leader lines F and L via the loop portion 22 of the connector 20 as shown in FIG. 1. The individual fishing and leader lines F and L can, for example, be tied to the eye 22a of the loop portion 22 and/or clipped into the snap 22b of the loop portion 22. When submerged in water W, the relative angular orientation of the axis A and the channel surface 60 of the sinker body 30 tends to orient the channel surface 60 such that relative movement between the device 10 and the water W results in water flowing over the channel surface 60. The water W can flow over the channel surface 60 in response to, for example, trolling with the fishing rod R, reeling-in the fishing line F, currents in the water W, combinations thereof, etc. Turbulence in the water flowing through the recess 62 and between the ridges 64 causes the device to move irregularly, e.g., to flutter, move from side-to-side, etc. The irregular movement of the sinker apparatus 10 is conveyed via the leader line L to the hook and bait arrangement H, which accordingly imparts movement to the bait that simulates a lifelike action.

The lifelike action of bait can be simulated by a fishing sinker having a body described in the present disclosure. Additionally, fishing line tangles can be reduced or avoided by an anti-tangle connection such as a connector described in the present disclosure.

From the foregoing, it will be appreciated that specific embodiments of the invention have been described herein for purposes of illustration, but that various modifications may be made without deviating from the spirit and scope of the invention. Aspects of the invention described in the context of particular embodiments may be combined or eliminated in other embodiments. Furthermore, while advantages associated with certain embodiments of the invention have been described in the context of those embodiments, other embodiments may also exhibit such advantages, and not all embodiments need necessarily exhibit such advantages to fall within the scope of the invention. Accordingly, the invention is not limited, except as by the appended claims.

I/We claim:

1. A fishing apparatus including a body disposed on both sides of a plane, the apparatus comprising:
a first body portion including a hole extending along an axis between first and second surfaces, the axis being disposed in the plane; and
a second body portion outwardly extending from the first body portion away from the axis, the second body portion including a channel surface, and the channel surface including individual ridges extending on both sides of the plane and a recess positioned between the individual ridges.

2. The fishing apparatus of claim 1 wherein the channel surface is obliquely oriented with respect to the axis.

3. The fishing apparatus of claim 1 wherein the channel surface is oriented with respect to the axis at an angle from 60 to 80 degrees.

4. The fishing apparatus of claim 1 wherein the channel surface is oriented with respect to the axis at an angle of approximately 75 degrees.

5. The fishing apparatus of claim 1 wherein the recess extends from the hole and parallel to the plane.

6. The fishing apparatus of claim 1 wherein the channel surface comprises the second surface of the first body portion.

7. The fishing apparatus of claim 1 wherein the second body portion further includes opposite side surfaces extending from the first body portion and outwardly flaring from one another.

8. The fishing apparatus of claim 7 wherein the individual ridges comprise convex contours adjoining the recess to a respective one of the side surfaces.

9. The fishing apparatus of claim 7 wherein the individual side surfaces are coupled together by an intermediate surface extending from the first body portion and being positioned between the first and second surfaces.

10. The fishing apparatus of claim 1 wherein the second body portion includes an end surface positioned distal from the first body portion, the end surface adjoining the channel, the individual side surfaces, and the intermediate surface.

11. A fishing device for use with a fishing line, the fishing device comprising:
a body including first and second portions, the first portion including a hole extending along an axis between first and second surfaces, the second portion defining a concave channel extending from the first body portion at an oblique angle with respect to the axis; and
a fishing line connector positioned in the hole and coupling the body to the fishing line.

12. The fishing device of claim 11 wherein the second body portion comprises individual ridges extending on opposite sides of the concave channel.

13. The fishing device of claim 11 further comprising:
means for sinking in water a bait connected to the fishing line; and
means for moving the means for sinking, whereby the means for moving causes the bait to move in simulated live action.

14. The fishing device of claim 11 further comprising:
means for reducing fishing line tangling with submerged objects in water.

15. A method of manufacturing a fishing device, the method comprising:
defining a mold cavity including a pin extending between first and second surfaces, the second surface including individual depressions on both sides of a protrusion, and the protrusion extending obliquely from the pin; and
selectively inserting a core in the mold cavity to control mold cavity volume.

16. The method of claim 15, further comprising:
varying the core to vary the mold cavity volume.

17. The method of claim 15, further comprising:
casting a body in the mold cavity; and
separating the body from the mold cavity.

18. The method of claim 17, further comprising:
coupling a fishing line connector to the body.
